(19) United States
(12) Patent Application Publication
(10) Pub. No.: US 2002/0083074 A1
(43) Pub. Date: Jun. 27, 2002

(54) Information distribution system, recording medium and program

(75) Inventor: Kazutaka Minoya, Tokyo (JP)

Correspondence Address: Cooper & Dunham LLP, 1185 Avenue of the Americas, New York, NY, 10036, US

(73) Assignee: Marks Hotels International Co., Ltd.

(21) Appl. No.: 09/849,561

(22) Filed: May 4, 2001

(30) Foreign Application Priority Data
Dec. 22, 2000 (JP) 2000-391073

(51) Int. Cl. G06F 7/00

(52) U.S. Cl. 707/102

(57) ABSTRACT

An information distribution system comprises a server agent for creating a reference database from data on a website in a server, and a user agent for collecting information and exchanging information while reflecting the taste of the user.

### CROSS-REFERENCE TO RELATED APPLICATIONS

This application is based upon and claims the benefit of priority from the prior Japanese Patent Application No. 2000-391073, filed Dec. 22, 2000, the entire contents of which are incorporated herein by reference.

### BACKGROUND OF THE INVENTION

This invention relates to information distribution techniques, and more particularly to an information distribution system, recording medium and program using a communication line and artificial intelligence.

Service providers providing accommodation-related information using a server on a website now provide, on the website, their particular accommodation-related information in html (hyper text markup language) format, or provide information by constructing their particular databases.

Further, when a user utilizes a service of the above accommodation-related information, they access, for example, a menu included in the provided information, or obtain information by executing, for example, keyword retrieval using the html format or the databases, or make a reservation on the basis of the obtained information.

In the prior art, the service providers providing accommodation-related information using a server on a website must newly construct, for example, a database in accordance with the type of new service. Further, even when using a website having, for example, a database, the task of changing the data format in accordance with a new service, which is very expensive, is required.

Moreover, when the user utilizes a service of the aforementioned accommodation-related information, it is difficult for them to attain target information from the large amount of information provided. In addition, time and effort are required for the user to collect information themselves, and the quality of information obtainable depends upon their retrieval skills.

### BRIEF SUMMARY OF THE INVENTION

It is the object of the invention to provide an information distribution system, recording medium and program, which do not require service providers to construct a new database or change a data format when they start to provide a new service, and which enable the user to easily collect target information.

According to an aspect of the invention, there are provided an information distributing system, recording medium and program, characterized in that the system for distributing accommodation-related information, comprising: a server connected to a communication line;

a server agent provided in the server and having artificial intelligence, the server agent including means for creating a reference database from a website or a database provided in the server; a user terminal connected to the communication line; and a user agent provided in the user terminal and having artificial intelligence, the user agent including means for reflecting a taste of a user, information collecting means and information exchanging means.

According to another aspect of the invention, there is provided a system for distributing accommodation-related information is characterized by comprising: an information provider connected to a communication line; a server connected to the communication line; a server agent provided in the server and having artificial intelligence, the server agent including means for creating a reference database from a website or a database provided in the server, and means for considering information from the information provider; a user terminal connected to the communication line; and a user agent provided in the user terminal and having artificial intelligence, the user agent including means for reflecting a taste of a user, information collecting means and information exchanging means.

According to yet another aspect of the invention, there is provided a computer-readable recording medium storing a program for operating a computer, for use in a system for distributing accommodation-related information, the system including: a server connected to a communication line; a server agent provided in the server and having artificial intelligence, the server agent creating a reference database from a website or a database provided in the server; a user terminal connected to the communication line; and a user agent provided in the user terminal and having artificial intelligence, the user agent reflecting a taste of a user, collecting information and exchanging information.

According to a further aspect of the invention, there is provided a computer-readable recording medium storing a program for operating a computer, for use in a system for distributing accommodation-related information, the system including: an information provider connected to a communication line; a server connected to the communication line; a server agent provided in the server and having artificial intelligence, the server agent including means for creating a reference database from a website or a database provided in the server, and means for considering information from the information provider; a user terminal connected to the communication line; and a user agent provided in the user terminal and having artificial intelligence, the user agent including means for reflecting a taste of a user, information collecting means and information exchanging means.

According to a yet further aspect of the invention, there is provided a program for operating a computer, for use in a system for distributing accommodation-related information, the system including: a server connected to a communication line; a server agent provided in the server and having artificial intelligence, the server agent creating a reference database from a website or a database provided in the server; a user terminal connected to the communication line; and a user agent provided in the user terminal and having artificial intelligence, the user agent reflecting a taste of a user, collecting information and exchanging information.

According to another aspect of the invention, there is provided a program for operating a computer, for use in a system for distributing accommodation-related information, the system including: an information provider connected to a communication line; a server connected to the communication line; a server agent provided in the server and having artificial intelligence, the server agent including means for creating a reference database from a website or a database provided in the server, and means for considering information from the information provider; a user terminal connected to the communication line; and a user agent provided in the user terminal and having artificial intelligence, the user agent including means for reflecting a taste of a user, information collecting means and information exchanging means.

Additional objects and advantages of the present invention will be set forth in the description which follows, and in part will be obvious from the description, or may be learned by practice of the present invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the present invention, and together with the general description given above and the detailed description of the preferred embodiments given below, serve to explain the principles of the present invention.

FIG. 1 is a view schematically illustrating the embodiment of the invention;

FIG. 2 is a flowchart useful in explaining the process of installing a server agent employed in the embodiment of the invention;

FIG. 3 is a flowchart useful in explaining the operation of the server agent executed in the embodiment when the structure of a database on a distribution-type shop server side is changed, and when recorded data is changed;

FIG. 4 is a flowchart useful in explaining an operation of the server agent executed in the embodiment when it receives information from an information provider;

FIG. 5 is a flowchart useful in explaining another operation of the server agent executed in the embodiment when it receives information from an information provider;

FIG. 6 is a view illustrating an operation and function of a user agent installed in a user terminal connected to a communication line and employed in the embodiment of the invention;

FIG. 7 is a view illustrating another operation and function of the user agent installed in the user terminal connected to a communication line and employed in the embodiment of the invention;

FIG. 8 is a view illustrating yet another operation and function of the user agent installed in the user terminal connected to a communication line and employed in the embodiment of the invention; and

FIG. 9 is a view illustrating a further operation and function of the user agent installed in the user terminal connected to a communication line and employed in the embodiment of the invention.

### DETAILED DESCRIPTION OF THE INVENTION

The embodiment of the invention will be described with reference to the accompanying drawings.

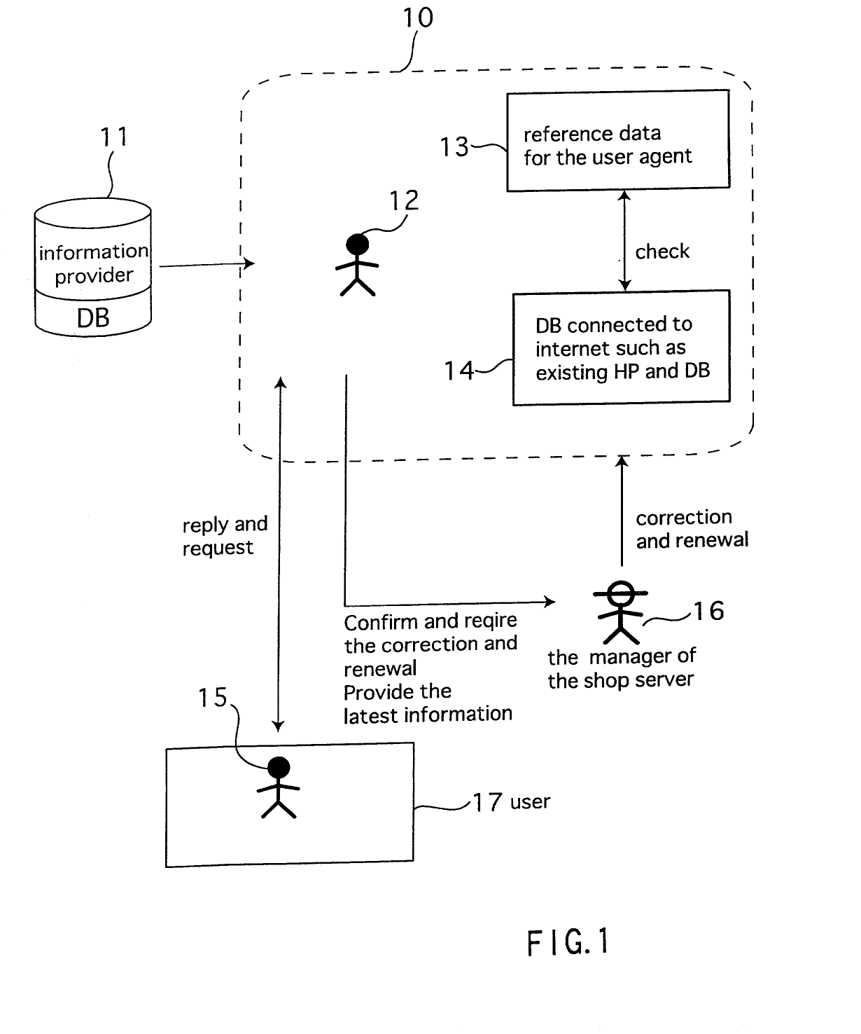

FIG. 1 is a view schematically illustrating the embodiment of the invention. As shown in FIG. 1, there is a shop server 10 connected to a communication line and managed by a shop server manager 16. The shop server 10 includes a server agent 12. A user 17 can access the communication line via a terminal that can be connected thereto. Similarly, the terminal has a user agent 15. Further, an information provider 11 is also connected to the communication line for exchanging information with the server agent.

The communication line is not limited to a particular one, but may be a network capable of transmitting and receiving data, such as the Internet, a LAN (Local Area Network), etc. Further, the shop server manager 16 or the information provider 11 may be a person, an application or a dedicated agent. The access terminal used by the user is not limited to a PC (Personal Computer) but may also be a cellular phone, home game console or a car navigator, etc.

First, a description will be given of a method for introducing the server agent 12 to the shop server 10.

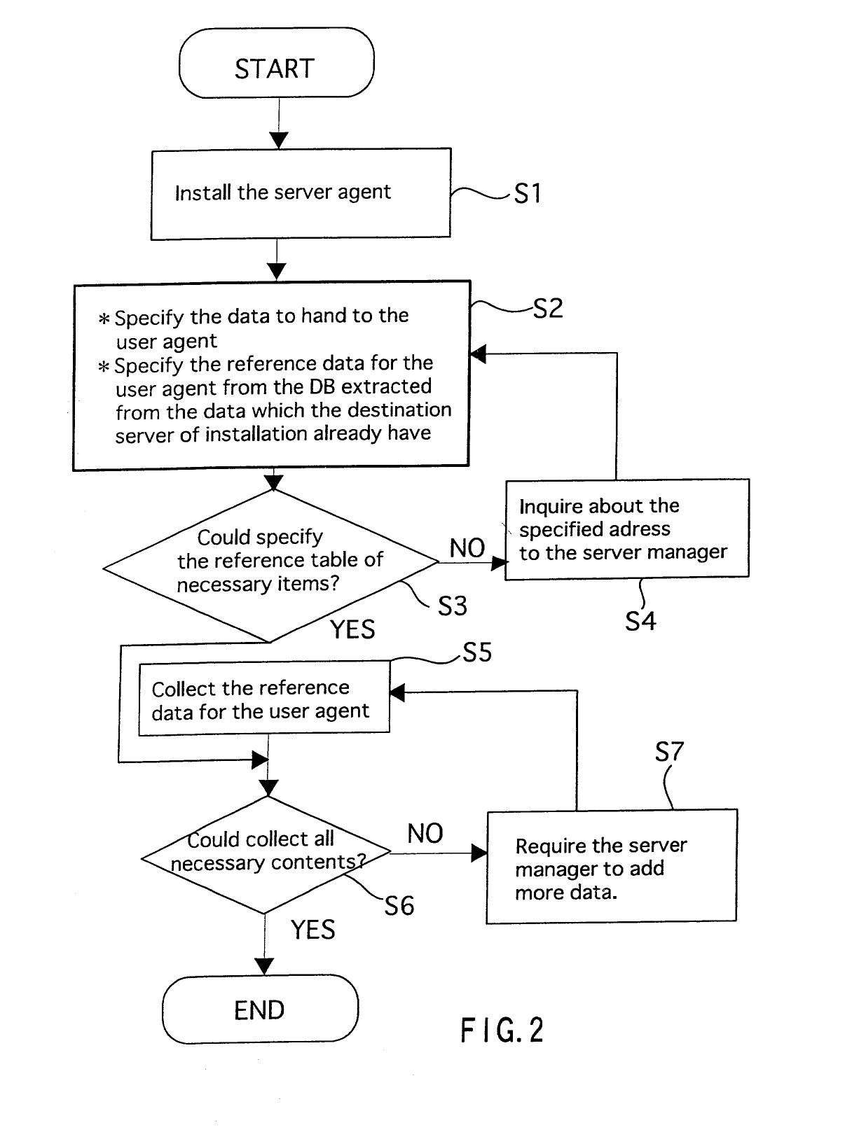

As shown in FIG. 2, the server agent 12 is installed in the shop server 10 (see FIG. 1) (step S1). Then, that data included in website data (e.g. old data on a website) prestored in the shop server 10 is designated, which is to be exchanged with the user agent 15 (step S2). It is checked whether or not the server agent 12 could specify a reference table of necessary items (step S3). The necessary item indicates, for example, accommodation data such as the name, the address, telephone number, mail address or floor plan of accommodation facilities, or data indicative of whether or not the facilities has a television, air conditioner, bathroom, bathhouse, near-by restaurant or souvenir shop, parking area, conference room or child development center, or accommodation peripheral data such as information on the prefecture, city, town or village to which the accommodation facilities belong, information on a tourist agency, commerce and industry association, products, food or traffic, etc., or personal record data on the user, such as general client attributes including sex, age or career, etc., partner information as to whether the tour is a family tour, a single tour or a group tour, accommodation use history, lodging fees, or other accommodation use fees, or ranking information such as hotel facilities, the degree of hospitality, cooking or alcoholic beverages, etc. The data items indicated by reference numerals 13 and 14 in FIG. 1 correspond to the necessary items.

If the server agent has not yet specified such a reference table, the program proceeds to step S4, where the server agent inquires the server manager of an address assigned to a to-be-referred item, followed by the program returning to step S2. On the other hand, if the server agent 12 has specified the reference table, the program proceeds to step S6, where it is checked whether or not the server agent 12 has collected all the contents of the necessary items. A case where not all contents of the necessary items are collected indicates, for example, a case where an address item is collected although it is not filled out.

If all the contents of the necessary items are not collected, the program proceeds to step S7, where the server agent 12 requires the server manager to add data for the necessary items. After that, the program proceeds to step S5, where the server agent 12 again collects data to be referred to by the user agent 15. If, on the other hand, all the contents of the necessary items are collected, the process of introducing the server agent 12 is terminated.

In addition to the function of collecting information, the server agent 12 has a function of checking whether or not the reference data is correct, a function of monitoring the updated history of a database, and a function of exchanging information with the external information provider 11, the user agent 15 and the database manager, etc. The information collection may be executed by an additionally-installed agent or by the user agent 15. Further, the server agent 12 is installed in each server for monitoring a database to be referred to by the user agent 15. The server agent 12 can urge the updating of, for example, a website that is not updated for more than a predetermined period. Accordingly, the reference data can be kept fresh.

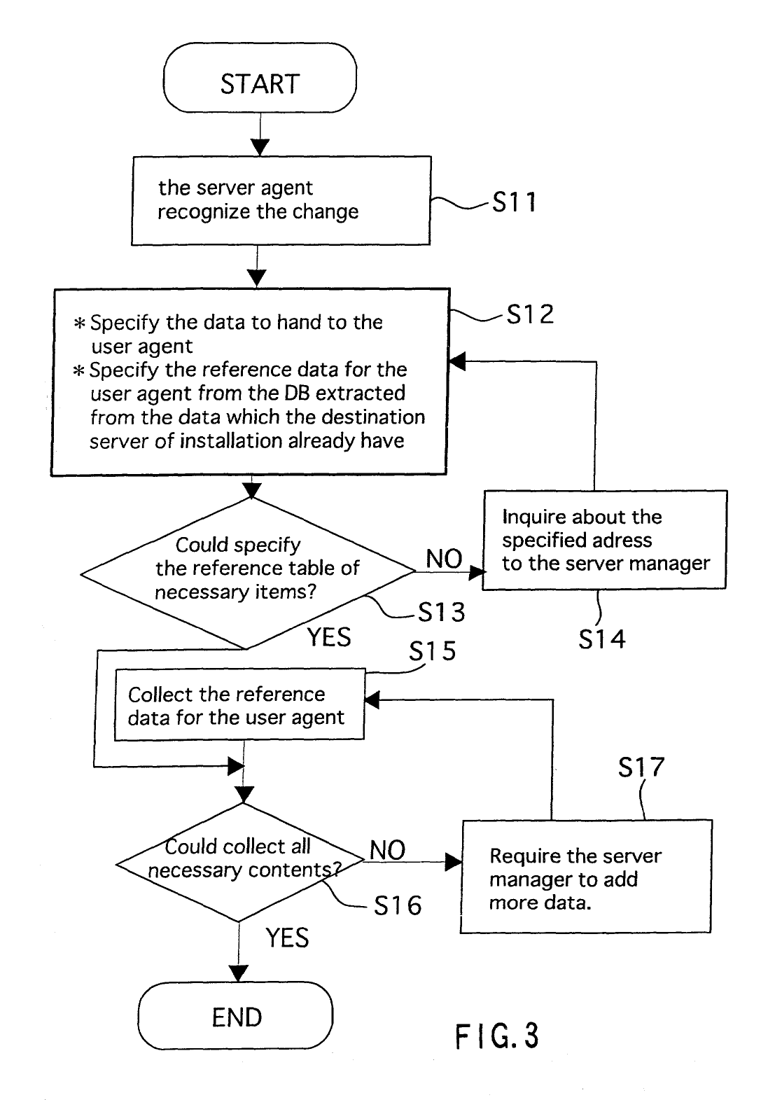

Referring now to FIG. 3, a description will be given of the operation of the server agent 12 executed when the structure of the database on the distribution-type shop server 10 side has been changed, and when record in the database has been changed (data addition or deletion). As shown in FIG. 3, at step S11, the server agent 12 recognizes a change in record. To reflect the contents of the change in the user agent reference database, the server agent 12 executes the same process as in FIG. 2 at steps S12-S17.

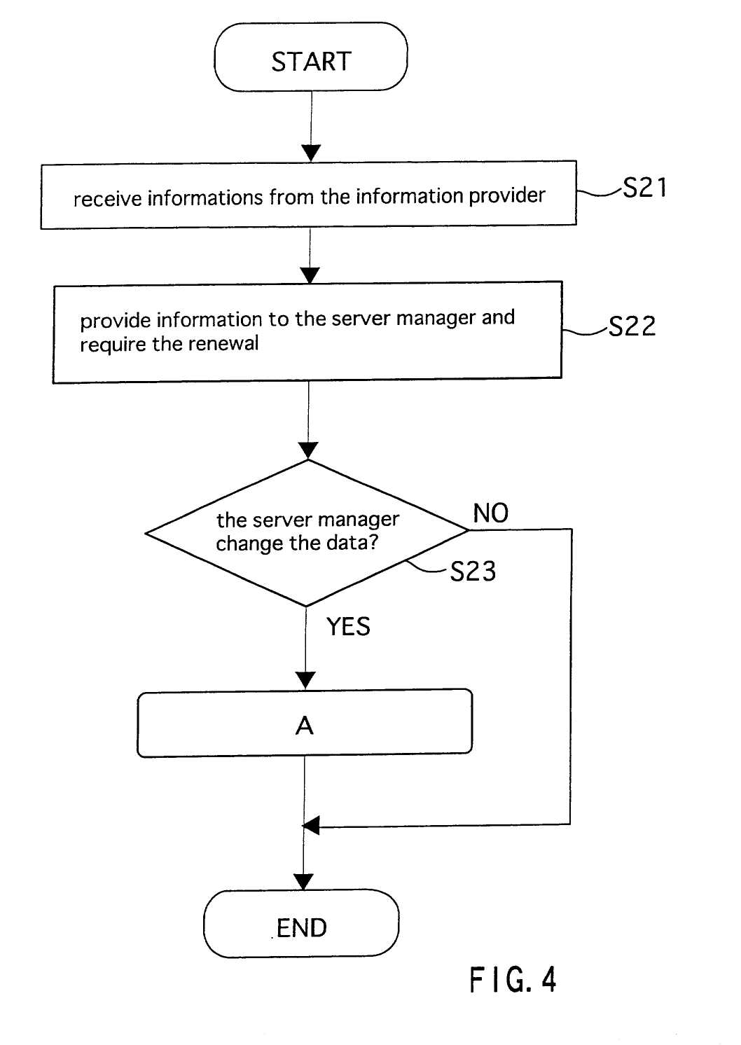

Referring then to FIG. 4, a description will be given of the operation of the server agent 12 executed when it has received information from the information provider 11. As shown in FIG. 4, first, at step S21, the server agent 12 receives information from the information provider 11. The information from the information provider 11 is, for example, information indicating that the law may be changed to raise consumption tax, or that a new hotel is opened. The server agent 12 supplies the received information to the server manager 16 to request it to update its data (step S22). Subsequently, the server manager 16 judges whether or not the data should be updated. For example, the server manager 16 judges that a rise in consumption tax should be reflected in its database after the rise is decided in a Parliamentary debate, while the new hotel should be registered. Thus, if the database is not to be updated, the process is terminated, whereas if the database is to be updated, process A is executed. As shown in FIG. 5, process A is similar to the process shown in FIG. 3. When new data is registered, the server agent 12 recognizes the change (step S24), thereby executing the processes of steps S25-S30 in the same manner as in FIG. 3.

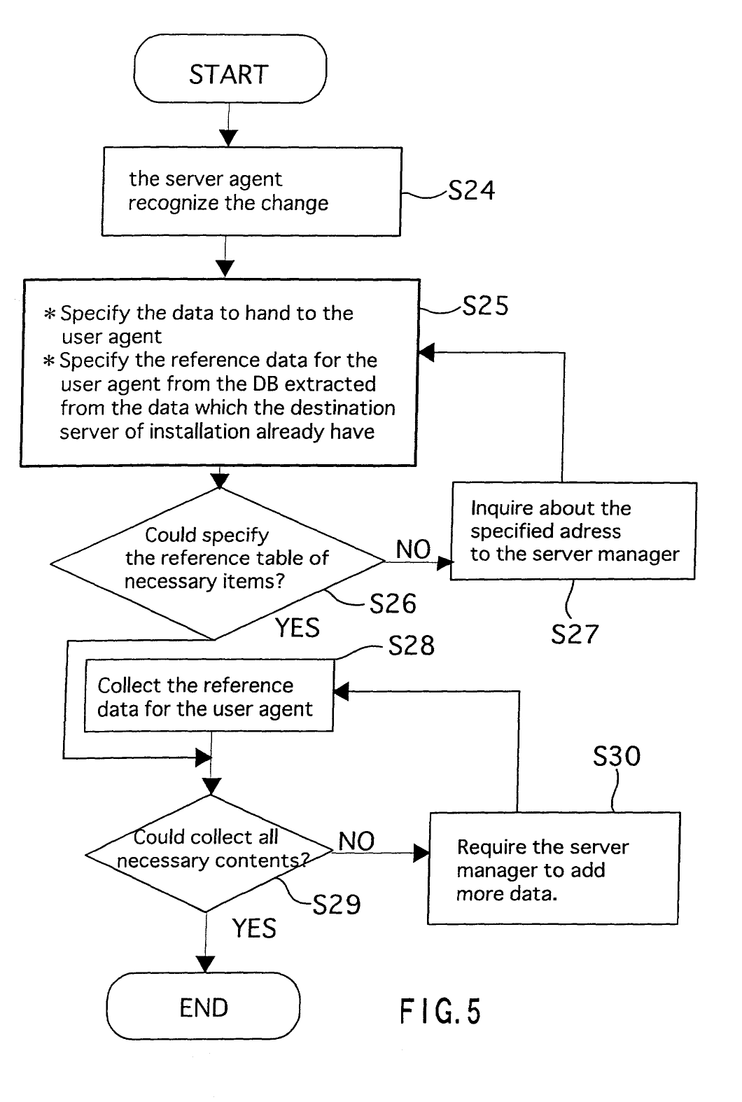

Referring to FIGS. 6-9, a description will be given of the operation and function of a user agent 45 installed in a terminal that can be connected to the communication line of a user 47. FIG. 6 illustrates an initial data input screen. The terminal connectable to the communication line is, for example, a terminal connectable to the Internet. First, as shown in FIG. 6, the terminal equipped with the user agent 45 asks the user 47 questions about, for example, favorite food, favorite hotels, places of accommodation facilities they have stayed at, age, sex, career, chronic illnesses, birth place, height or weight, etc. The answers to the questions are input. Input of the answers may be performed by voice or a keyboard, etc. Thus, the input means is not important. This input operation enables the user agent 45 to have a database that reflects preference information of the user 47.

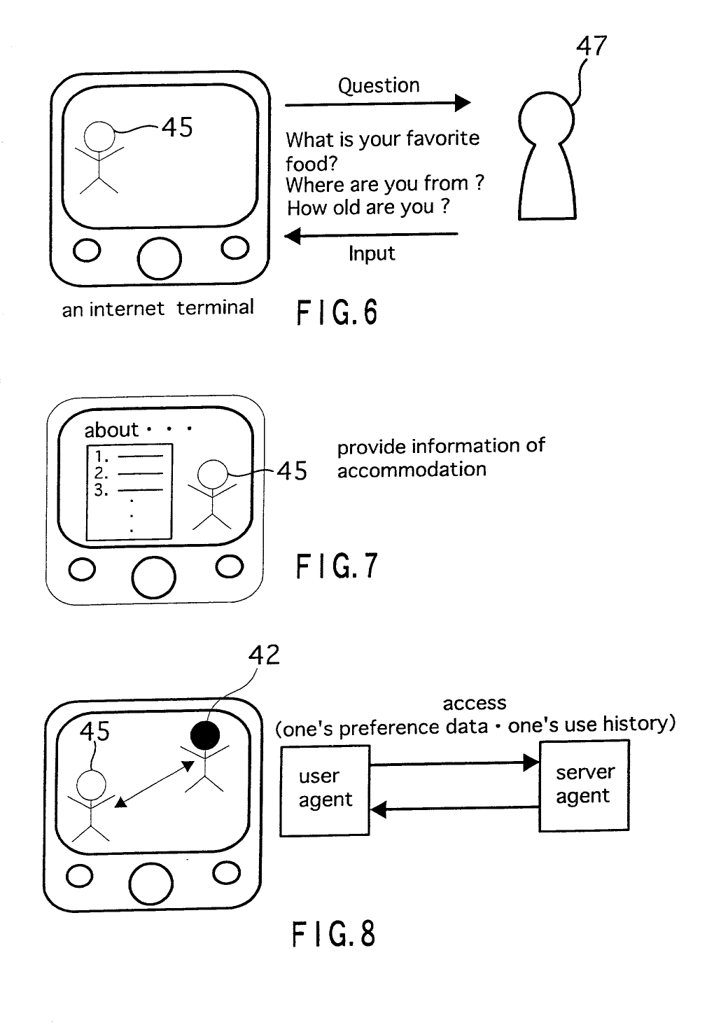

FIG. 7 illustrates a screen for providing information to the user 47, while FIG. 8 illustrates the exchange of information between the user agent 45 and a server agent 42. As shown in FIG. 7, the user agent 45 in the terminal displays, on the terminal screen, information in the server directly, or displays accommodation-related information collected via the server agent 42. In this case, the accommodation-related information can be displayed in the order of a user's preference that reflects the user's preference database. Further, the history of use (e.g. the results of selection on provided menus, retrieved information, accommodation facilities the user often uses, etc.) of the user 47 can also be read and used at any time by accumulating the information in a database that the server agent 42 can access, as a result of exchanging information between the user agent 45 and the server agent 42.

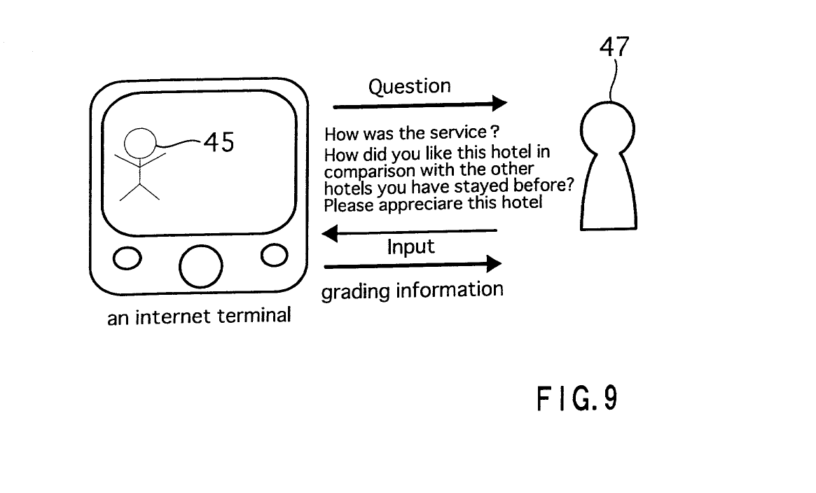

FIG. 9 illustrates an input screen that displays ranking data. In this case, the aforementioned provided-information or information concerning, for example, a shop the user 47 found is input. Accommodation-related information can be ranked by inputting data indicative of, for example, whether or not the hotel the user stayed at the previous night was good, or indicative of the rank of the hotel between hotels the user utilized so far. If this information is supplied to other users, they can use it as ranking information. Moreover, information concerning other accommodation facilities such as pensions, and/or information concerning attractions held near a hotel the user will stay at can be incorporated in the ranking information. In addition, the “accommodation ranking information” may be classified into total ranking information, category ranking information and ranking information for each user, thereby providing more practical ranking results.

The user agent 45 can exchange information with another user agent 45. If information concerning the history of use of a certain user is not sufficient, the exchange of information between the user agents of users having similar tastes widens the range of information. Further, since the user agent 45 has a relaying function and a conversion function, data of various formats can be read. Furthermore, the users themselves can input information concerning, for example, a pool and a bar, etc. in a hotel, which they can often use. Thus, the user agent 45 is very useful as a memo managing tool for accommodation-related information. If the user remembers that the user agent stores the accommodation-related information, they can instantly obtain, therefrom, necessary information such as the owner, business group or the services, etc. of a hotel, an external catalog selling site, an external auction site, other information sites, or other databases, etc.

Also, if the user would like to collect accommodation-related information concerning an area in which they are now staying at, the addition of a function of detecting the present position of the user to the user terminal enables the user terminal to automatically detect its present position. Specifically, its present position is detected by acquiring the IP address of a base station that is connected to a GPS (such as a car navigation function) terminal or an Internet terminal of the user terminal, or by directly inputting position information to the user terminal.

When the user agent or the server agent collects external information as recited below, the information reflects the needs of the user. When collecting information in a certain accommodation, the user agent or the server agent collects, at regular intervals, information by, for example, meta search in which an overall search is executed using a plurality of existing search engines, or information from a ranking database or an external accommodation-related information database. Further, the agent updates the collected information at regular intervals.

For providing more particular information other than general accommodation-related information on the Internet, a difference database is constructed as an additional database that does not overlap with the existing database. When the difference database is used, it provides more particular information concerning, for example, accommodation facilities that satisfy the needs of the user. More specifically, suppose that a high school teacher A in charge of a school excursion project has a qualification estimation list concerning collective bathing, which can be used as a necessary reference item of accommodation information. The embodiment of the invention can assist the teacher A by providing information on the size of a bathtub and the number of showers, etc., and hence information on an appropriate accommodation. Further, concerning nationwide accommodation facilities suitable for a school excursion, the embodiment can provide “high-school excursion accommodation estimation” ranking information or a “teacher-A-dedicated estimation” ranking information, in addition to general total accommodation estimation ranking information.

Moreover, the embodiment of the invention can obtain a database registration fee (space fee) or a brokerage commission from accommodation facilities as target shops, information of which is provided to the user.

If there are many hotels, companies, pensions and persons, etc. related to accommodation facilities, which have their respective IP addresses and particular servers, even information concerning an accommodation and a company, etc. that the user used newly or without reservation can be accumulated in, for example, a database, without the guidance of the user agent, by recognizing their IP addresses.

The application used in the embodiment is published and distributed for free on the Internet. This application is written in JAVA and can be installed in different types of terminals. Furthermore, this application has an XML function and can realize communication with a database.

To realize a function of learning the taste of the user, a neural network theory is used.

As described above, the embodiment of the invention enables a service provider to start a new service without newly constructing a database or changing a data format, and enables the user to easily collect target information. Moreover, the use of the distribution-type server causes an information provider to be responsible for information they provide, which means that the server manager is not required to be responsible for the information. Also, the distribution-type server, which does not depend upon a particular server as a data center, can realize a reliable, high-speed operation and hence minimize the occurrence of an inaccessible state due to, for example, a downed server. In addition, since, in the system of the embodiment of the invention, information resources in existing databases or on websites are collected and used with only difference information added, using the server agent, the system can be developed at a low cost. Furthermore, the provision of up-to-date accommodation ranking information by scoring based on a specific estimation scale or by the direct estimation of a visitor realizes accommodation information guide services of high reliability. Also, since a website managed by each accommodation is included in information-collecting sources, local governments, for example, which promote the cultivation of local homepage creators, may welcome the system of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A system for distributing accommodation-related information, comprising:
a server connected to a communication line;
a server agent provided in the server and having artificial intelligence, the server agent including means for creating a reference database from a website or a database provided in the server;
a user terminal connected to the communication line; and
a user agent provided in the user terminal and having artificial intelligence, the user agent including means for reflecting a taste of a user, information collecting means and information exchanging means.

2. The system according to claim 1, wherein the server agent manages the reference database.

3. The system according to claim 1, wherein the server agent urges a manager of the server to reflect information obtained from an external source, in data stored in the server.

4. The system according to claim 1, wherein the server agent adjusts a data format.

5. The system according to claim 1, wherein the user agent can exchange information with another user agent.

6. The system according to claim 1, wherein the user agent can be moved between mobile terminals.

7. The system according to claim 1, wherein the user agent can exchange information with the user.

8. A system for distributing accommodation-related information, comprising:
an information provider connected to a communication line;
a server connected to the communication line;
a server agent provided in the server and having artificial intelligence, the server agent including means for creating a reference database from a website or a database provided in the server, and means for considering information from the information provider;
a user terminal connected to the communication line; and
a user agent provided in the user terminal and having artificial intelligence, the user agent including means for reflecting a taste of a user, information collecting means and information exchanging means.

9. The system according to claim 8, wherein the server agent manages the reference database.

10. The system according to claim 8, wherein the server agent urges a manager of the server to reflect information obtained from an external source, in data stored in the server.

11. The system according to claim 8, wherein the server agent adjusts a data format.

12. The system according to claim 8, wherein the user agent can exchange information with another user agent.

13. The system according to claim 8, wherein the user agent can be moved between mobile terminals.

14. The system according to claim 8, wherein the user agent can exchange information with the user.

15. A computer-readable recording medium storing a program for operating a computer, for use in a system for distributing accommodation-related information, the system including:
a server connected to a communication line;
a server agent provided in the server and having artificial intelligence, the server agent creating a reference database from a website or a database provided in the server;
a user terminal connected to the communication line; and
a user agent provided in the user terminal and having artificial intelligence, the user agent reflecting a taste of a user, collecting information and exchanging information.

16. A computer-readable recording medium storing a program for operating a computer, for use in a system for distributing accommodation-related information, the system including:
an information provider connected to a communication line;
a server connected to the communication line;
a server agent provided in the server and having artificial intelligence, the server agent including means for creating a reference database from a website or a database provided in the server, and means for considering information from the information provider;
a user terminal connected to the communication line; and
a user agent provided in the user terminal and having artificial intelligence, the user agent including means for reflecting a taste of a user, information collecting means and information exchanging means.

17. A program for operating a computer, for use in a system for distributing accommodation-related information, the system including:
a server connected to a communication line;
a server agent provided in the server and having artificial intelligence, the server agent creating a reference database from a website or a database provided in the server;
a user terminal connected to the communication line; and
a user agent provided in the user terminal and having artificial intelligence, the user agent reflecting a taste of a user, collecting information and exchanging information.

18. A program for operating a computer, for use in a system for distributing accommodation-related information, the system including:
an information provider connected to a communication line;
a server connected to the communication line;
a server agent provided in the server and having artificial intelligence, the server agent including means for creating a reference database from a website or a database provided in the server, and means for considering information from the information provider;
a user terminal connected to the communication line; and
a user agent provided in the user terminal and having artificial intelligence, the user agent including means for reflecting a taste of a user, information collecting means and information exchanging means.
